(19) United States
(12) Patent Application Publication
(10) Pub. No.: US 2014/0327524 A1
(43) Pub. Date: Nov. 6, 2014

(54) METHOD AND APPARATUS PERTAINING TO PRECONFIGURING IN FACILITATING THE READING OF RFID TAGS

(71) Applicant: WAL-MART STORES, INC., Bentonville, AR (US)

(72) Inventors: Nicholaus A. Jones, Fayetteville, AR (US); Wallace Carrell King, Rogers, AR (US); Michael Jeffrey Galvin, Bentonville, AR (US)

(73) Assignee: Wal-Mart Stores, Inc., Bentonville, AR (US)

(21) Appl. No.: 13/875,608

(22) Filed: May 2, 2013

(51) Int. Cl. G06K 7/00; G06K 19/07

(52) U.S. Cl. CPC G06K 7/0008; G06K 19/0723
USPC 340/10.42

(57) ABSTRACT

Some embodiments provide methods to facilitate reading a plurality of radio frequency identification (RFID) tags, comprising: receiving, within a RFID tag reader, identification information corresponding to one or more RFID tags of interest; interrogating a plurality of RFID tags while the RFID tag reader is not in communication with a remote processor; receiving multiple corresponding RFID tag responses from the RFID tags; evaluating at the RFID tag reader each of the multiple RFID tag responses relative to the identification information; identifying, as a function of the evaluating, a plurality of RFID tags of interest; and producing, at the RFID tag reader, end user-perceivable indications corresponding to at least one RFID tag response from each of the RFID tags of interest to thereby inform an end user with respect to a corresponding reading state as regards to the plurality of RFID tags.

### TECHNICAL FIELD

This invention relates generally to the reading of Radio Frequency Identification (RFID) tags.

### BACKGROUND

Radio Frequency Identification (RFID) tags are known in the art. These so-called tags often assume the form factor of a label or a literal “tag” but are also sometimes integrated with a host article and/or its packaging. RFID tags typically comprise an integrated circuit and one or more antennas. The integrated circuit typically carries out a variety of functions including modulating and demodulating radio frequency signals, data storage, and data processing. Some integrated circuits are active or self-powered (in whole or in part) while others are passive, being completely dependent upon an external power source (such as an RFID tag reader) to support their occasional functionality.

There are proposals to utilize RFID tags to individually identify individual items. The Electronic Product Code (EPC) as managed by EPCGlobal, Inc. represents one such effort in these regards. EPC-based RFID tags each have a unique serial number to thereby uniquely identify each tag and, by association, each item associated on a one-for-one basis with such tags. The very nature of RFID-based technology, coupled with a correspondingly potentially enormous number of individually-tagged items, gives rise to a number of challenges. As one simple example in these regards is the potential large number of tags to be read.

### SUMMARY OF THE INVENTION

Several embodiments of the invention advantageously address the needs above as well as other needs by providing methods to facilitate reading a plurality of radio frequency identification (RFID) tags, the methods comprising: receiving, within a RFID tag reader and from a remote processor that is separate from the RFID tag reader, identification information corresponding to one or more RFID tags of interest, wherein the identification information distinguishes the one or more RFID tags of interest from other RFID tags that are not currently of interest; interrogating, after having received the identification information, a plurality of RFID tags while the RFID tag reader is remote from and not in communication with the remote processor; receiving at the RFID tag reader multiple corresponding RFID tag responses from various ones of the plurality of RFID tags; evaluating locally at the RFID tag reader each of the multiple RFID tag responses relative to at least the identification information; identifying, as a function of the evaluating, a plurality of RFID tags that are RFID tags of interest; and producing, locally at the RFID tag reader and in response to identifying the plurality of RFID tags of interest, end user-perceivable indications corresponding to at least one RFID tag response from each of the plurality of RFID tags of interest to thereby inform an end user of the RFID tag reader with respect to a corresponding reading state as regards to the plurality of RFID tags.

Other embodiments provide apparatuses to facilitate reading a plurality of radio frequency identification (RFID) tags. At least some of these apparatuses comprise: a memory configured to store identification information received from a remote processor that is separate and remote from the apparatus, wherein the identification information corresponds to one or more RFID tags of interest and distinguishes the one or more RFID tags of interest from other RFID tags that are not currently of interest; an RFID tag reader configured to interrogate a plurality of RFID tags while the RFID tag reader is remote from and not in communication with the remote processor, and to receive multiple corresponding RFID tag responses from various ones of the plurality of RFID tags; a control circuit operatively coupled with the RFID tag reader and the memory, wherein the control circuit is configured to receive the multiple corresponding RFID tag responses from the RFID tag reader; locally evaluate each of the multiple RFID tag responses relative to at least the identification information; identify, as a function of the evaluation, a plurality of RFID tags are RFID tags of interest; and produce, in response to identifying the plurality of RFID tags of interest, end user-perceivable indication signals corresponding to RFID tag responses from each of the plurality of RFID tags of interest; and an annunciator operably coupled with the control circuit, wherein the annunciator is configured to receive the end user-perceivable indication signals from the control circuit and to generate end user-perceivable indications corresponding to the RFID tag responses from each of the plurality of RFID tags of interest as a function of the end user-perceivable indication signals to thereby inform an end user of the apparatus with respect to a completeness level of the reading of the plurality of RFID tags.

Still further, some embodiments provide methods to facilitate reading a plurality of radio frequency identification (RFID) tags, the methods comprising: interrogating, from a handheld wireless RFID tag reader, a plurality of RFID tags; receiving at the RFID tag reader multiple corresponding RFID tag responses from various ones of the plurality of RFID tags; determining whether the RFID tag reader is in range with and in communication with a remote processor that is separate from the RFID tag reader; evaluating, locally at the RFID tag reader when the RFID tag reader is not within communication with the remote processor, each of the multiple RFID tag responses relative to at least identification information received at the RFID tag reader from the remote processor and locally stored at the RFID tag reader, wherein the identification information corresponds to one or more RFID tags of interest and distinguishes the one or more RFID tags of interest from other RFID tags that are not currently of interest; comparing, locally at the RFID tag reader when the RFID tag reader is not within communication with the remote processor, information in each of the multiple RFID tag responses with one or more identifiers defined within identification information received at the RFID tag reader from the remote processor and locally stored at the RFID tag reader; identifying, locally at the RFID tag reader when the RFID tag reader is not within communication with the remote processor and in response to the comparing, one or more of the plurality of RFID tag responses as RFID tags of interest when the one or more identifiers correspond to previously-established identifiers defined within the identification information received at the RFID tag reader from the remote processor; determining, locally at the RFID tag reader when the RFID tag reader is not within communication with the remote processor and as a function of the evaluating, whether a currently-read RFID tag is an RFID tag of interest; storing locally within the RFID tag reader at least a portion of information from each of the plurality of RFID tag responses received from RFID tags of interest; and producing, locally at the RFID tag reader when the RFID tag reader is not within communication with the remote processor and in response to determining that one or more currently-read RFID tags are RFID tags of interest, an end user-perceivable indication corresponding to the RFID tag responses from the plurality of RFID tags of interest to thereby inform an end user of the RFID tag reader with respect to a corresponding reading state as regards to the plurality of RFID tags.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 comprises a flow diagram as configured in accordance with various embodiments of the invention.

FIG. 2 comprises a flow diagram as configured in accordance with various embodiments of the invention.

FIG. 3 comprises a flow diagram as configured in accordance with various embodiments of the invention.

FIG. 4 comprises a timing diagram as configured in accordance with various embodiments of the invention.

FIG. 5 comprises a block diagram as configured in accordance with various embodiments of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “some embodiments,” “some implementations” or similar language means that a particular feature, structure, or characteristic described in connection with the embodiment is included in at least one embodiment of the present invention. Thus, appearances of the phrases “in one embodiment,” “in an embodiment,” “in some embodiments,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present embodiments provide methods, processes, systems and apparatuses configured to readily detect and then uniquely identify individual items (sometimes referred to as products) within a manufacturing facility, a cargo container, a staging area, a storage container, in a retail display area, or other such collections or groupings. Further, the identification of these items can be achieved remote from one or more servers and/or processors that contain information about these items, such as an inventory listing. Additionally, some embodiments, distinguish between items to uniquely identify individual items and/or associate items as items of interest.

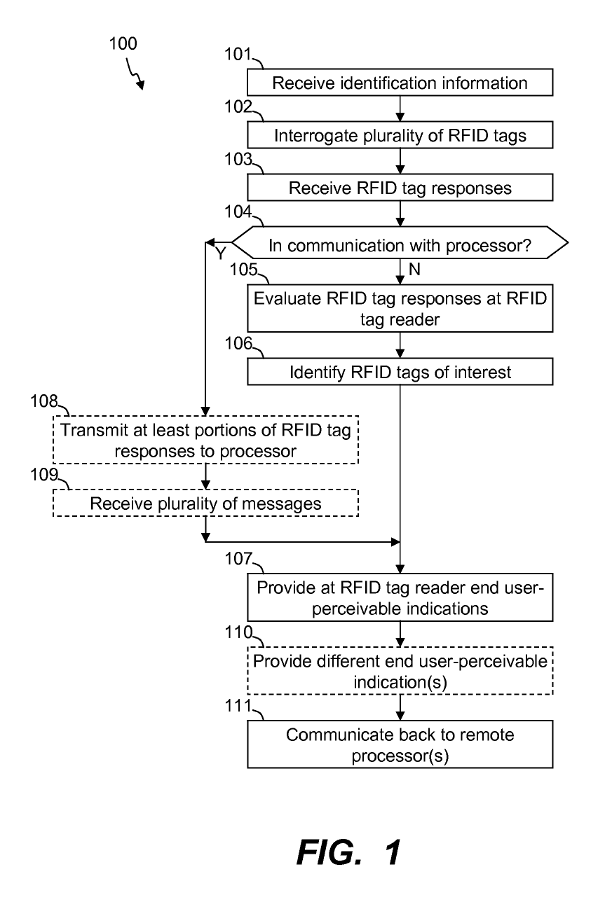

FIG. 1 shows a simplified flow diagram of an exemplary process 100 of facilitating the reading of a plurality of radio frequency identification (RFID) tags, in accordance with some embodiments. In step 101, a RFID tag reader receives identification information corresponding to one or more products and/or RFID tags of interest from a remote server or processor that is separate from the RFID tag reader. The identification information distinguishes the one or more RFID tags and/or products of interest from other RFID tags and/or products that are not currently of interest. The RFID tag reader locally stores the identification information for use when the RFID tag reader is remote from and not in communication with the server or processor. The identification information can include substantially any information that can distinguish an RFID tag from other RFID tags. For example, the identification information can include, but is not limited to information and/or numbers that identify a manufacturer, a type of item or product, a specific item, Universal Product Code (UPC) numbers or portions of UPC numbers, stock keeping unit (SKU) numbers or portions of SKU numbers, identification of one or more modules, or other such identification information or combinations of such information. Locally storing the identification information, in at least some embodiments, preconfigured the RFID tag reader to perform evaluations of RFID tag responses.

In step 102, the RFID tag reader interrogates a plurality of RFID tags while the RFID tag reader. Again, the RFID tag reader can implement the tag reads while remote from and not in communication with the remote processor or server. In some embodiments, interrogating passive RFID tags, the interrogation comprises transmitting one or more a radio frequency signals having a particular frequency (such as, for example, a relatively-low frequency (such as 125 kHz), a relatively-high frequency (such as 13.56 MHz), a relatively-ultrahigh frequency (such as 900 MHz), or a relatively-extremely high (such as 2.4 GHz)) to the RFID tags. The signal received at the RFID tag provides energy that powers the tag circuitry. This circuitry, upon recognizing a need to respond to the interrogation, then modulates the signal to provide corresponding responsive data. Generally speaking, each of these RFID tags is typically attached to (or comprise a part of) a given item (or the packaging for that item) such as an item being offered for retail sale. (It will therefore be understood that a given such “item” may comprise a plurality of related physically-discrete components. For example, the “item” may comprise a box of cookware that contains two pots with two corresponding lids along with a frying pan.)

Also generally speaking, in many application settings this interrogation step 102 corresponds to a relatively limited physical area. Examples include, but are not limited to, a given display shelf or a plurality of shelves as comprise a given display, a so-called end-cap display, a given display rack or a plurality of display racks in a limited area (such as an area of 100 square feet, 150 square feet, 200 square feet, and so forth), module or modularized offering of items, and/or other such areas. In such an application setting, the end user will typically be initiating their RFID tag reader to begin reading the RFID tags within the coverage area of their RFID tag reader with the intention of eventually concluding that read and then moving on to begin a new interrogation step. (These teachings will also accommodate, however, simply leaving the reader in a constantly interrogating state while reading and processing RFID tags as per the remainder of this process and while moving from one area to another.)

Accordingly, this interrogation step 102 comprises interrogating the plurality of RFID tags, and often simultaneously interrogating multiple RFID tags. Further, in some implementations, the interrogation can be considered an interrogation en masse of the aforementioned plurality of RFID tags. As used herein, this expression interrogating and/or “interrogating en masse” refers to interrogating one or more RFID tags, and typically interrogating a plurality of RFID tags in a setting where the proximity of the RFID tags to one another is sufficiently close that interrogation by the RFID tag reader will generate a plurality of largely contemporaneous RFID tag responses from these various RFID tags such that response prioritization, re-transmission, and/or collision remediation aspects of the RFID-signaling protocol being employed are likely utilized in order to permit each of the interrogated RFID tags to successfully respond to the interrogation.

The reading of RFID tags through an RFID tag reader is further described in U.S. Application Publication No. 2012/0013441 to Ulrich, which is incorporated herein by reference in its entirety.

In step 103, the RFID tag reader receives multiple corresponding RFID tag responses from various ones of the plurality of RFID tags. The specific nature of these responses will of course vary depending upon the particular RFID coding scheme being used. For the sake of illustration but without intending any particular limitations in these regards, it will be presumed here that the RFID coding scheme is compatible with an EPCGlobal-based EPC coding scheme. Accordingly, each RFID tag response will typically include a unique serial code and such information as a SKU number for the item that corresponds to the RFID tag. Typically, however, the RFID tag responses include tag identification information. This tag identification information can identify a manufacturer, a type of item, a specific item, a module identification, and/or other such identification information or combinations of such information. As one example, the tag identification information can include a Universal Product Code (UPC) number that is used to identify items associated with corresponding RFID tags. Other tag identification information can additionally or alternatively be used.

The interrogation and receipt of RFID tag responses, as well as the structure and content of such RFID tag responses, comprises a well understood area of endeavor. Furthermore, these teachings are not particularly sensitive to the selection of any particular approaches in these regards. Accordingly, for the sake of brevity, further elaboration in these regards will not be provided here.

In optional step 104, the RFID tag reader can determine whether it is within range of and/or in communication with the remote processor. In some embodiments, the RFID tag reader is configured to locally evaluate RFID tag responses and determine whether RFID tag responses correspond to RFID tags of interest. As described above, in some embodiments, the RFID tag reader is provided with relevant identification information preconfiguring the RFID tag reader to locally perform at least some evaluations and/or filtering of RFID tag responses.

Accordingly, in step 105, the RFID tag reader locally evaluates RFID tag responses at least in relation to the identification information locally stored at the RFID tag reader. Again, the RFID tag responses include tag identification information. In some embodiments, the RFID tag reader can utilize at least a portion of the tag identification information and evaluate this information to determine whether at least that portion of the information corresponds with at least a portion of the identification information and/or a previously established identifier specified within the identification information locally stored at the RFID tag reader. In step 106, the RFID tag reader identifies those RFID tags that are RFID tags of interest as a function of the evaluation performed in step 105.

At step 107, the process 100 provides, at the RFID tag reader, a plurality of end user-perceivable indications corresponding to the RFID tag responses from the various ones of the plurality of RFID tags, and typically at least one RFID tag response from each of the plurality of RFID tags of interest. These end user-perceivable indications in turn serve to inform an end user of the RFID tag reader with respect to a corresponding reading state as regards to the plurality of RFID tags. An illustrative but not necessarily limiting list of such reading states can comprise:
(a) actively reading a number of RFID tags with more tags likely remaining to be read in this plurality of RFID tags;
(b) actively reading some remaining RFID tags but the read process for this plurality of RFID tags is nearing completion;
(c) actively reading one or more remaining RFID tags but the read process for this plurality of RFID tags may now be complete;
(d) there do not appear to be any further RFID tags in this plurality of RFID tags to read.

In some embodiments, the RFID tag reader comprises a part of an integrated end-user platform that includes the structure and/or programming to carry out some or all of the evaluations, actions, steps, and functionality presented herein. In some implementations and/or others approaches, however, the end-user platform communicates with one or more remote processors. Further, the end-user platform can be configured, in at least some embodiments, to communicate with the one or more processors relevant information obtained through the end-user platform such that the one or more remote processors perform some or all of the evaluations, actions, steps, and functionality presented herein. In a typical application setting the RFID tag reader can communicate with such a remote processor (or processors, as desired) via a corresponding wireless interface. Numerous examples and appropriate wireless interfaces abound. Non-limiting illustrations in these regards are infrared-based communications, Bluetooth-compatible communications, IEEE 802.11-compatible communications, wide-area communications (such as any of a variety of cellular telephony-based communications), and so forth. In some embodiments, the RFID tag reader additionally or alternatively couples to one or more remote processors using a non-wireless connection (such as one or more electrical conductors, optical pathways (such as optical fibers), or the like).

Accordingly, in some implementations, when the RFID tag reader is in communication with one or more of the remote processors, some or all of the evaluation of the RFID tag responses can be performed by the one or more remote processors. In some embodiments, when it is determined in step 104 that the RFID tag reader is in communication with the one or more remote processors the process 100 advances to optional step 108. At optional step 108, the RFID tag reader transmits at least a portion of at least some of the aforementioned interrogation RFID tag responses to one or more remote processors. The one or more remote processors can evaluate some or all of the information provided to identify the one or more RFID tags of interest. In optional step 109, the RFID tag reader receives a plurality of corresponding messages from the one or more remote processors relative to the RFID tags of interest. The process 100 then advances to step 107 providing the plurality of end user-perceivable indications generated as a function of the corresponding messages from the one or more processors. These end user-perceivable indications generated as a function of the corresponding messages from the one or more processors can be generated at the RFID tag reader in lieu of end user-perceivable indications generated as a function of evaluations of RFID tag responses performed at the RFID tag reader or in combination with end user-perceivable indications generated as a function of evaluations of RFID tag responses performed at the RFID tag reader.

In some embodiments, when desired, the evaluation performed by the RFID tag reader in step 105 (or similar evaluation performed partially or fully at the one or more remote processors when relevant) accommodates further evaluation and/or filtering the RFID tag responses to more selectively provide the aforementioned end user-perceivable indications. For example, the evaluation can further limit which RFID tags are tags of interest and/or limit which RFID tag responses are to be associated with user-perceivable indications.

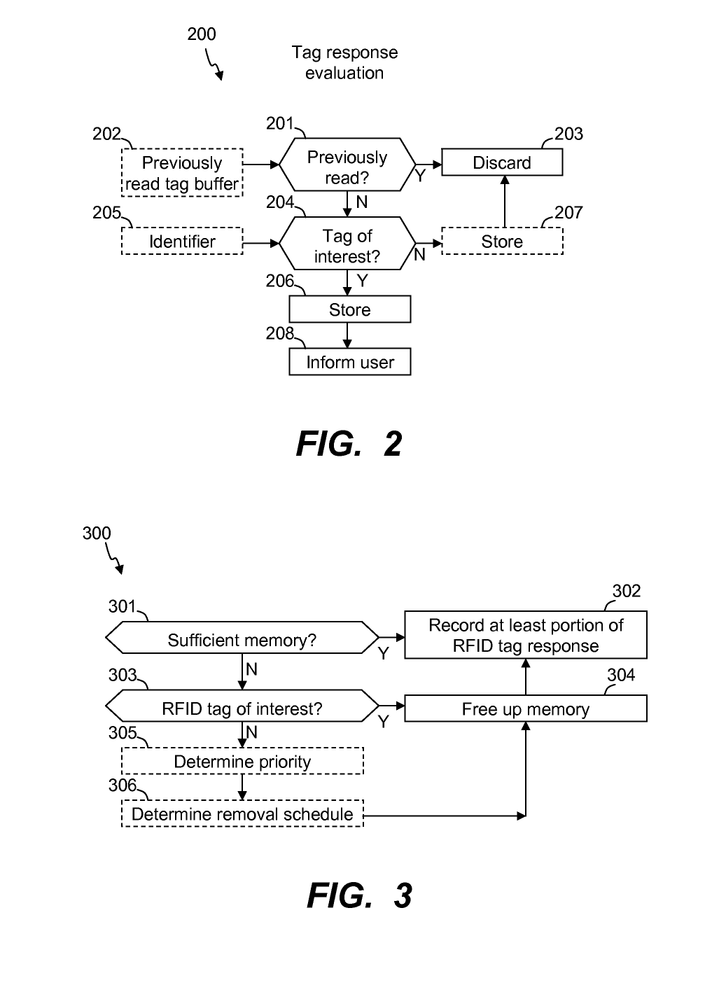

FIG. 2 provides an illustrative example of a process 200 providing at least some of the evaluation and/or filtering of RFID tag responses, in accordance with some embodiments. Again, the process 200 is typically performed locally by the RFID tag reader when the RFID tag reader is not in communication with the one or more remote processors. Accordingly, in some embodiments, some or all of the process 200 is performed as at least part of the evaluation in step 105 of the process 100 of FIG. 1. Similarly, some or all of the process 200 may be performed by the one or more processors. In some embodiments, in step 201, each RFID tag response can be assessed to determine whether that RFID response corresponds to an already-read RFID tag. By one approach, this can comprise determining whether an RFID tag response being evaluated corresponds with and/or refers to an RFID tag that was previously read within some limited or threshold period of time (such as ten seconds, one minute, five minutes, twenty-four hours, or such other period as may be of interest in a given application setting). Such information may be gleaned, for example, by referring to a previously-read tag buffer 202 stored within the RFID tag reader and that serves to store such information. In some embodiments, the information in the previously-read tag buffer may be a limited or portion of the information obtained in the RFID tag response to the interrogation. When a current RFID tag response being considered does in fact correspond to an RFID tag that previously responded to the present interrogation and was accordingly already read, this process 200 can provide, in step 203, for discarding or otherwise ignoring this particular RFID tag response being evaluated. In some embodiments, an end user-perceivable indication is not produced for the ignored or discarded RFID tag responses.

As another example in these regards, and in lieu of the foregoing or in combination therewith, step 204 can provide for determining whether a currently-read RFID tag is an RFID tag of interest. In some embodiments, this can comprise comparing information in the RFID tag response with the identifier information 205 (e.g., comparing to one or more identifiers and/or other information specified in the identification information) locally stored at the RFID tag reader.

As an illustrative example in these regards, and without intending any corresponding limitations, such an identifier and/or identifier information might comprise a stock-keeping unit (SKU) number of interest. In such a case, RFID tag responses that convey that particular SKU number, and/or other such relevant tag identification information that can be correlated with the identification information provided to and stored on the RFID tag reader, are accepted as corresponding to RFID tags of interest. Other identifiers and/or information can additionally or alternatively be used, such as but not limited to, serial numbers, manufacturer identifiers and/or identifier numbers, UPC numbers or portions of UPC numbers, and the like or combinations of such identifying information. As a further illustrative example, and without limitation, some embodiments provide manufacturer's and product's identifiers as in EPC standard as at least part of the identification information and/or identifiers. Similarly, the identification information may comprise customized identifier and/or other such information defined by a retailer, manufacturer, distributor or the like (e.g., first plurality of bits of an identifier can define an identifier, while a second plurality of identifiers can identify an item). Accordingly, in some embodiments, the RFID tag reader locally evaluates each of the multiple RFID tag responses by at least in part comparing information in each of the multiple RFID tag responses with one or more identifiers specified within the identification information and stored on the RFID tag reader.

As an additional or alternative illustrative example in these regards, and without intending any corresponding limitations, such an identifier and/or identifier information might comprise one or more module identifiers or other such location identifiers (e.g., in accordance with a planogram, a storage or cargo container identifier, a truck identifier, etc.). Retailers often present their items (sometimes referred to as products) as modularized offerings. In some instances, these modularized offering use one or more support platforms of choice, such as a shelf or set of shelves, a tabletop, a display rack, and so forth. In many application settings these modules are physically discrete displays of items that are offered for retail sale. In such a case, it can be helpful to inventory such items on a module-by-module basis. Accordingly, the identification information may comprise one or more module identifiers, other such location identifiers and/or other such information that can be used to distinguish some RFID tags (and corresponding items) from other RFID tags (which are generally referred to below as module identifier).

As such, in some embodiments the process 200 can include additional separate steps or as part of the evaluation in step 204 in determining whether an RFID tag response corresponds to an RFID tag of interest, where the RFID tag responses can be evaluated locally at the RFID tag reader in determining whether an RFID tag response correlates with an identifier for a predefined module of items, which is distinct from other modules of items (or other location identifiers, container identifiers, and the like). For the sake of illustration but without intending any particular limitations in these regards, the RFID tag reader can read RFID tags corresponding to a plurality of items that are collected together as a module, access an identifier that corresponds to a given such module and then using that module identifier filter the RFID tag readings to distinguish those RFID tags read that are RFID tags of interest from those RFID tags read that are not of interest. When the RFID tag reader determines the corresponding RFID tag response correlates with the identifier of the module of items, the RFID tag reader can, in lieu of or in combination of one or more other factors (e.g., whether the RFID tag was already-read, whether the RFID tag corresponds with the identification information or additionally corresponds with other portions of the identification information, etc.), identify the corresponding RFID tag as an RFID tag of interest.

In some embodiments, the module identifier for the module (or location identifier, cargo identifier, etc.) may be obtained by reading an optical code that corresponds to the given module of items (e.g., optical code on a display structure, optical code on a shipping order or label, etc.). Additionally or alternatively, some embodiments obtain this identifier by reading an RFID tag that specifically correlates to the given module of items. Similarly, the module or location identifier(s) can be obtained by receiving the identifier from the remote processor, entered by an end user who is, for example, participating in the RFID tag reading process, or otherwise supplied to the RFID tag reader. These teachings will accommodate other approaches in these regards as desired. In some embodiments, this module identifier can serve to recall corresponding information that can serve, directly or indirectly, as filter criterion or criteria used by the RFID tag reader in evaluating and/or filtering RFID tag responses. For example, when a given identifier is associated with a given stock-keeping unit (SKU) number (or numbers), those SKU numbers can be used to identify and/or eliminate RFID tag responses that present alternative SKU content or otherwise identify these responses as corresponding to RFID tags not of interest in the current interrogation session.

Modules, module based inventorying and RFID tag scanning based on modules is further described in U.S. Application Publication No. 2012/0013440 to von Bose et al., which is incorporated herein by reference in its entirety.

Some embodiments include step 206 where the RFID tag reader records some or all of the information from the RFID tag response when an RFID tag or response is identified in step 204 as being of interest, regardless of the evaluation and/or filtering applied. For example, when the RFID tag reader is not in communication with the remote processor (or processors), the RFID tag reader can be configured to record some or all of the information from RFID tag responses from RFID tags of interest to be later communicated to the remote processor when communication is established between the RFID reader and the remote processor. This allows the remote processor to acquire the relevant information regarding RFID tags even when the RFID tags are remote from the processor and/or a communication network (e.g., wireless and/or wired) over which the remote processor is configured to communicate.

Similarly, in some embodiments, the process 200 includes optional step 207, where the RFID tag reader identifies RFID tags in step 204 as not of interest when the corresponding RFID tag responses do not include tag identification information that match and/or correspond with the identifier information stored at the RFID tag reader. The RFID tag reader can further record some or all of the information from the RFID tag responses for those RFID tags not of interest. In other embodiments, those RFID tag responses that do not include tag identification information that match and/or correspond with identifier information stored at the RFID tag reader are discarded in step 203.

In step 208, regardless of how evaluated and/or filtered, pursuant to such an approach those RFID tags that pass the evaluation and/or filtering criterion (or criteria, as desired) are then used to support informing the end user. In the specific example illustrated, this will comprise RFID tags that are newly read (e.g., pursuant to this round of interrogation, within a threshold time limit, etc.) and, optionally, that also match in some predefined manner one or more previously-established identifiers and/or identification information. More specifically, when using this approach, RFID tags that pass the evaluation and/or filtering criterion (or criteria) will be used to prompt the provision of the aforementioned end user-perceivable indications.

Because the RFID tag reader is typically portable, and usually handheld by the end user, the RFID tag reader often has a limited size. The amount of memory available within the RFID tag reader is also typically limited. The memory stores firmware, software, applications, codes, parameters, identification information, time information, timestamps, other such relevant information or combinations of such information. Further, in some embodiments, the RFID tag reader may also store some or all of the information from RFID tag responses for RFID tags of interest and in some instances for RFID tags that are not of current interest.

As described above, in response to the interrogation the RFID tags return the RFID tag responses that are received by the RFID tag reader. The number of responses can be extremely large, in part because of the number of RFID tags that may be within range of the interrogation signal (e.g., a wireless broadcast). Further, the RFID tags typically continue to respond to an interrogation signal or signals while the signal is being received, and as such can result in the RFID tag reader receiving numerous responses from the same RFID tag or RFID tags. This can be beneficial in that interference, signal collisions and the like may inhibit the accurate reception of a first RFID response from a particular RFID tag, but a subsequent RFID response from the particular RFID tag may accurately be received.

As such, some embodiments manage the available memory such that the RFID tag reader can continue to operate and obtain relevant information and provide that information to the remote processor or other system. FIG. 3 shows an illustrative example of a process 300 providing memory management of the RFID tag reader, in accordance with some embodiments. In some implementations, the process 300 can be used to implement some of the steps of the process 200 of FIG. 2, such as but not limited to steps 206 and/or 207. In step 301, the RFID tag reader, for each received RFID tag response, determines whether there is a sufficient amount of memory available to the RFID tag reader to record at least a desired portion of or all of the RFID tag response. When there is sufficient memory, the RFID tag reader, in step 302, records some or all of the RFID tag response.

Alternatively, when it is determined in step 301 that there is insufficient memory, the process 300 continues to step 303 where the RFID tag reader evaluates each RFID tag response that is accurately received to determine whether the RFID tag response corresponds to an RFID tag of interest. Typically, the RFID tags of interest are considered to be of greater importance in a current interrogation, and as such are given greater priority over RFID tags that are not of interest to the current interrogation. These RFID tags that are considered not of interest to the current interrogation, however, may still be of some importance to the one or more remote processors. For example, when determining what items are in a given display, module, trailer, storage or cargo container, truck or the like, it can be beneficial to acquire RFID tag response information from all potential RFID tags through a single interrogation process or session (which may include multiple interrogations).

When the RFID tag response being evaluated is associated with an RFID tag of interest, the RFID tag reader in step 304 frees up memory. Typically, the RFID tag reader identifies stored information corresponding to one or more RFID tags that are not currently of interest and deletes this information or otherwise indicates this information to be overwritten. In some embodiments, the RFID tag reader may select the information to be deleted and/or overwritten based on a first-in-first-out (FIFO) schedule, a last-in-first-out (LIFO) schedule or some other procedure or schedule for selecting information to be deleted or overwritten.

Similarly, in some implementations, the RFID tag reader may further be provided with a prioritization schedule for RFID tags that are not of interest and/or that are of interest. For example, the processor may instruct, the end user may request, and/or it may be predicted by the one or more remote processors that an end user intends to interrogate RFID tags at a given location (e.g., a given module or modules, a preselected location within a store layout or planogram, a give remote or external storage (e.g., a storage container outside the store), a given truck delivering items to the store, a cargo container, a staging area, a retail display area, a portion of a manufacturing facility, and the like). As such, the remote processor may predict which items, and thus which corresponding RFID tags, are likely to be detected during an interrogation.

The remote processor can designate a priority of the RFID tags that are anticipated to respond to an interrogation, for example based on such knowledge and/or predictions. For the sake of illustration but without intending any particular limitations in these regards, an end user may be intending to go outside a store to a storage container to perform an RFID tag scan. This may be scheduled by the remote processor and/or selected by the end user. With the knowledge that the end user is intending to interrogate the storage container, the remote processor (or processors) may predict that the interrogation is expected to receive RFID tag responses from RFID tags corresponding to men's denim jeans, women's denim jeans, women's blouses, and sporting equipment. Accordingly, the remote processor may primarily be interested in the woman's jeans, and thus, designate the woman's jeans as the items of interest and the corresponding RFID tags as the tags of interest. The remote processor may further designate the other predicted items with other priorities, such as designating the men's jeans with a first priority of RFID tags (items) of non-interest, the women's blouses with a second priority of RFID tags of non-interest, and the sporting equipment with a third priority of items/RFID tags of non-interest. Based on this prioritization, the RFID tag reader in freeing up memory in step 304 may identify memory use associated with an RFID tag response of a lowest priority (and may apply a FIFO/LIFO or other such schedule to free up memory) in selecting information to be deleted and/or overwritten in freeing up the memory. It is contemplated that other types of prioritization may be applied, and in some instances, the prioritization is not based on predicted RFID tags expected to response. Accordingly, in some embodiments, the RFID tag reader may be given general prioritization (e.g., based on manufacturer, based on product line, based on customer demand, or other such prioritization and/or combinations of such prioritization).

Referring back to step 303, when it is determined that the RFID tag response corresponds with an RFID tag that is not currently of interest, some embodiments may discard the RFID tag response. Other embodiments, however, continue to optional step 305 where the RFID tag reader determines whether a priority is associated with the RFID tag not of interest, and identifies the priority when relevant. In optional step 306, a schedule to free up memory associated with recording information from an RFID tag response received from an RFID tag that is not currently of interest is identified. Again, such schedules can include a FIFO, LIFO, or other such schedules. Further, such schedules may be different for different priority levels or based on other factors.

Once the schedule to free up memory is identified the process continues to step 304 where memory is freed up in accordance with the schedule, and the priority when relevant. With memory available, some embodiments continue to step 302 where the RFID tag reader records (or overwrites) the relevant information from the RFID tag response to the freed up memory. Again, this includes the information from RFID tag responses from RFID tags of interest, and in some instances where sufficient memory is available, can potentially also include information from RFID tag responses from some or all RFID tags that are not of interest.

Referring back to FIG. 1, as described above, the RFID tag reader locally evaluates RFID tag responses in generating end user-perceivable indications. The end user-perceivable indications notify the end user of the RFID tag reader with respect to a corresponding reading state as regards to the plurality of RFID tags subject to the interrogation, and in some instances specific to RFID tags of interest. Again, in some embodiments, the RFID tag reader locally evaluates the RFID tag responses and locally produces end user-perceivable indications, typically, corresponding to at least one RFID tag response from each of the plurality of RFID tags of interest to thereby inform an end user of the RFID tag reader with respect to a corresponding reading state as regards to the plurality of RFID tags and/or a completeness level of the reading of the plurality of RFID tags.

The specific end user-perceivable indications provided can be audible if desired. For example, short chirps, pops, clicks, or the like can serve in these regards, in which case the indications can be essentially audibly identical to one another. If desired, slightly or significantly different sounds can be employed to help the end user distinguish between them. As a simple example in these regards, short tones having a frequency of 600 Hz and 900 Hz could be used in an alternating manner if desired.

These sounds can be rendered using any of a variety of known approaches including but not limited to synthesizing the sounds, playing back a pre-recorded sound, and so forth. Generally speaking, for many application settings it will serve well if these individual audible sounds are relatively short (such as, for example, no longer than about 300 milliseconds in duration, or 200 milliseconds in duration, or 100 milliseconds in duration, as desired). This can be helpful when reading dozens or even hundreds or thousands of RFID tags during a single interrogation activity.

Depending upon the nature of the audible sound (such as, for example, it's amplitude envelope) it may be useful to prevent any overlap between temporally adjacent audibilizations (to thereby help the end user to distinguish one indication from another). In such a case, a minimum period of silence between such audibilizations may be specified, such as a minimum of 20 milliseconds, 50 milliseconds, 100 milliseconds, or the like.

In other cases it may be acceptable to permit the individual audible indications to overlap somewhat with one another. Here, however, it may be useful to limit the amount of overlap to no more than some maximum amount. For example, the amount of temporal overlap may be limited to no more than about five percent, ten percent, or twenty-five percent of the total duration of the indication as desired.

When using an audible indicator, these teachings will accommodate providing a plurality of different audible indicators to thereby permit a given end user to select a particular favored indicator. This can permit a given end user, for example, to select an audible indicator having a pitch/frequency that is readily perceived by that particular end user. In some embodiments, the pitch and/or frequency may vary depending on the state and/or completeness level to provide further feedback to the user.

In lieu of an audible indicator, or in combination therewith, these teachings will also accommodate the end user-perceivable indication being provided as a visually-perceivable indicator if desired. This can comprise, for example, one or more flashing/strobing light-emitting diodes or incandescent bulbs having a desired color or colors. Similarly, multiple different LEDs of differing colors may be provided that are illuminated and/or flashed. Further, the illumination or flashing of different colors may further correspond to a tag reading state and/or completeness level. This could additionally or alternatively comprise, if desired, providing a particular animated graphic on an active full-color or monochromatic display. Numerous other possibilities of course exist in these regards. So configured, an end user with a partial or complete hearing disability can still make satisfactory use of these teachings. Such an approach will also accommodate the challenges presented by a particularly noisy application setting (such as a factory floor, loading dock, or the like). Using a visually-perceivable indicator instead of an audible indicator may also be preferred when reading RFID tags in a retail setting during business hours to thereby avoid distracting, confusing, or irritating shoppers.

Further in lieu of the foregoing, or again in combination with either or both an audible or visual indicator, the end user-perceivable indication can comprise a haptically-based indication. This might comprise, for example, a short vibration that the end user perceives through their hand when holding the RFID tag reader during the interrogation process. (Various vibratory mechanisms are known in the art and find application, for example, in cellular telephones and video-game controllers. Accordingly, no further description regarding such mechanisms need be provided here.) Other such user-perceivable indications can be utilizes in lieu of or in combination with one or more of the above.

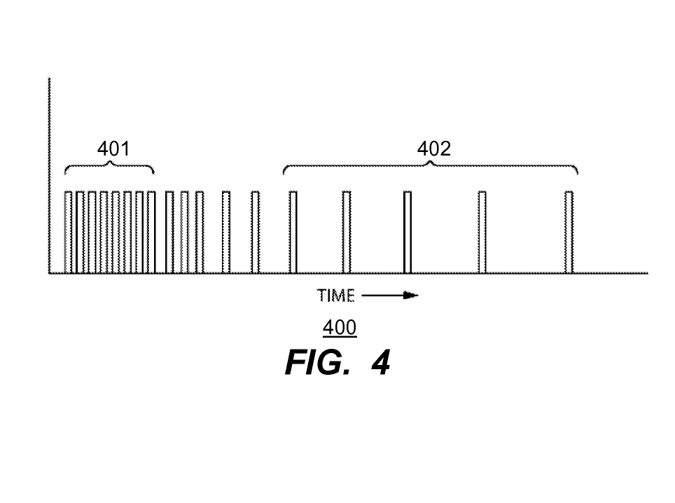

FIG. 4 shows a simplified graphical representation of timing diagram graphically depicting occurrences over time of end user-perceivable indications during an interrogation session 400 as configured in accordance with some embodiments. The aforementioned end user-perceivable indications can be provided, produced and/or otherwise indicated to the end user at a rate that varies over the course of reading the plurality of RFID tags during an interrogation and/or plurality of interrogations. This, for example, can serve to indicate to the end user information regarding the various read states described above. As illustrated, at the beginning 401 of an interrogation session 400 the individual end user-perceivable indications are temporally dense (and are possibly being provided as fast as possible subject to whatever overlap/separation requirements may be mandated). Accordingly, in some implementations, each end user-perceivable indication may represent multiple detections of RFID tag responses, and in some implementations multiple detections of RFID tag responses from RFID tags of interest. In the later portion 402 of the interrogation session 400, however, the individual end user-perceivable indications are spaced further apart. In this particular example, the spacing between individual end user-perceivable indications in fact grows larger as time passes.

Such a presentation strategy not only provides the end user with an affirmative and positive indication of read events but also serves to provide the end user with a strong, intuitive understanding regarding when substantially all or all available RFID tags of interest have been read. In particular, a rapid presentation of read indicators that gradually winds down as the temporal separation between subsequent indicators grows provides an easily-perceived and intuitively grasped understanding regarding when the read process for a particular plurality of RFID tags is nearing completion and/or is complete. This, in turn, permits the end user to move on with confidence to a next area where RFID tags are to be similarly read and/or return to a location where the RFID tag reader is again in communication with the remote processor (or processors) so that the RFID tag reader can transmit the results of the RFID tag interrogation session to the remote processor.

In some cases, as when the RFID signaling protocol and/or received-data processing is sufficiently slow, such a result can accrue by providing such indications substantially in real-time with respect to when the corresponding responses were received (or as offset by some small amount such as a few (or a few dozen) milliseconds). In other cases, and particularly when the system can process a large number of responses in a short period of time (such as, for example, 50 responses per second or more), it may be useful to artificially provide the corresponding indicators in the manner described above. For example, in an application setting where the system can interrogate, receive, and process 200 RFID tags in less than two seconds, it may nevertheless be helpful to provide the end user-perceivable indications in a manner as generally suggested by the illustration of FIG. 4 over the course of, say, five or ten seconds. This will permit the end user, for example, to actually have the cognitive opportunity to sense and detect the slowing down of the indicators and hence to better intuitively sense when the reading process concludes.

Referring again to FIG. 1, when desired, this process 100 will also optionally accommodate the step 110 of providing at the RFID tag reader, and typically determined and generated by the RFID tag reader, an end user-perceivable indication that is different than the above-noted indications to uniquely and specifically signal when interrogation of the plurality of RFID tags is complete or complete to a sufficient degree of accuracy. Such an indication will typically follow the aforementioned plurality of end user-perceivable indications. This step 110 can be based, for example, upon detecting at the RFID tag reader that a predetermined amount of time (such as one second, two seconds, five seconds, or the like) has passed without the RFID tag reader having receiving an interrogation response from an RFID tag of interest, a predefined number of tags are read (e.g., based on a number of expected RFID tags to be detected, which can be in accordance with the identification information provided to the RFID tag reader), and/or other such conditions.

In step 111, the RFID tag reader transmits to the one or more remote processors at least portions of the information recorded at the RFID tag reader from each of the plurality of RFID tag responses received from the RFID tags of interest, and typically all of the information stored at the RFID tag reader from the RFID tags from which a response is received at least during the most recent RFID tag interrogation session. This transmission can be in response to the RFID tag reader detecting that the RFID tag reader is in communication with the remote processor after having interrogated the plurality of RFID tags. Additionally or alternatively, the transmission of the information may, in some embodiments, be in response to a request or command from the one or more remote processors.

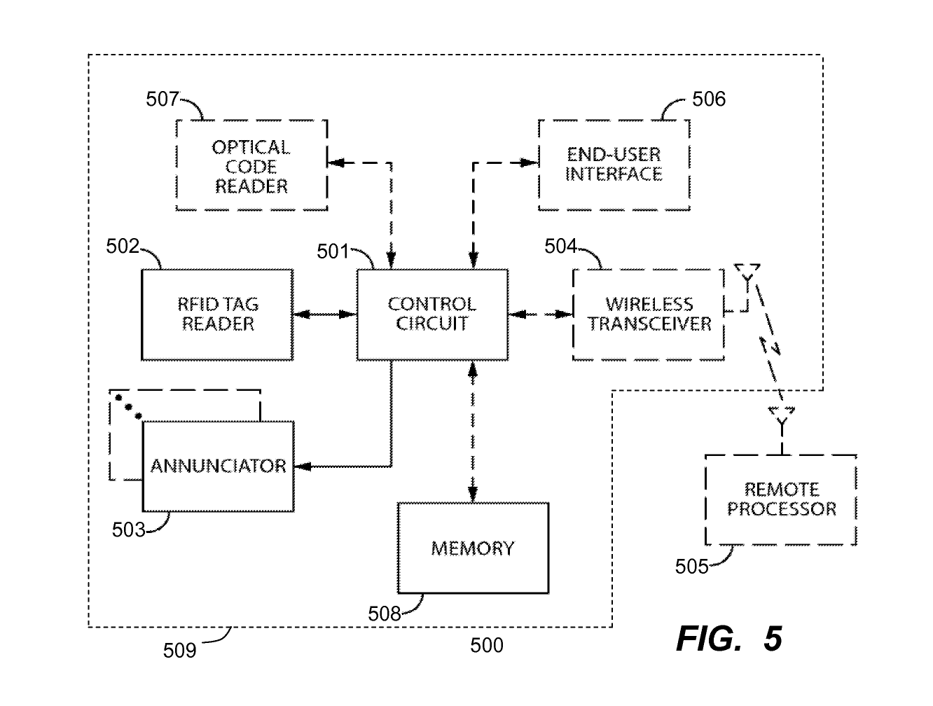

The above-described processes are readily enabled using any of a wide variety of available and/or readily configured platforms, including partially or wholly programmable platforms as are known in the art or dedicated purpose platforms as may be desired for some applications. FIG. 5 illustrates and exemplary, simplified block diagram as configured in accordance with various embodiments. In some embodiments, the RFID tag reader can comprise a part of an integrated end-user platform that includes additional structure and/or programming to carry out some or all of the actions, steps, and functionality presented herein.

In the illustrative example of FIG. 5 the end-user platform 500 comprises a control circuit 501 that operably couples to an RFID tag reader 502 and one or more annunciators 503. Such a control circuit 501 can comprise a fixed-purpose hard-wired platform or can comprise a partially or wholly programmable platform. All of these architectural options are well known and understood in the art and require no further description here. This control circuit 501 is configured (using, for example, ordinary programming approaches as are known in the art) to carry out one or more of the steps, actions, and/or functions described herein. Further, the control circuit 501 can be implemented through one or more processors, microprocessors, central processing unit, logic, local digital storage, firmware and/or other control hardware and/or software.

The RFID tag reader 502, in some embodiments, generates the RFID tag interrogations of the RFID tags. This is typically a wireless signal that activates the RFID tags, as described above. Such RFID tag reader architectures are well known and understood in the art and require no further description here. In some embodiments, the control circuitry 501 couples with the RFID tag reader 502 to receive the RFID tag responses and is further configured to compare information in each of the multiple RFID tag responses with the identification information (e.g., one or more identifiers defined within the identification information) and stored in the memory, and to identify an RFID tag as an RFID tag of interest when an identifier specified within a corresponding one of the multiple RFID tag responses corresponds to previously-established identifiers defined within the identification information.

The annunciator 503 can comprise any of a variety of annunciators as are known in the art. This can include, as suggested above, audible indicators, visual indicators, and/or haptic indicators.

If desired, this end-user platform 500 can further comprise one or more wireless transceivers 504 of choice. This wireless transceiver 504 can operably couple to the control circuit 501 and can serve to permit the latter to communicate with one or more remote processors 505 as described above. In such a case, the remote processor(s) 505 can themselves be configured to carry out at least one of the steps, actions, and/or functions described herein. (If desired, one could employ a non-wireless transceiver for such purposes, either in lieu of the wireless transceiver 504 or in combination therewith.)

For many application settings it will be useful for the end-user platform 500 to further include an optional end-user interface 506 that operably couples to the control circuit 501 (and/or to other components such as the RFID tag reader 502 as desired). This end-user interface 506, by one approach, can serve to permit the end user to prompt, control, and otherwise direct at least some of the operability states of the platform 500. For example, the end-user interface 506 can include a trigger-styled switch that, when asserted by the end user, will cause the RFID tag reader 502 to transmit RFID tag interrogation signals and to receive corresponding responses. As another simple example in these regards, this end-user interface 506 can include a potentiometer-styled controller that permits the end user to control the volume of an audible annunciator 503.

By another approach, in combination with the foregoing or in lieu thereof, this end-user interface 506 can provide informational output to the end user. As one simple example, the end-user interface 506 can include a pilot light to indicate when the platform 500 is powered on. As another simple example, the end-user interface 506 can comprise an active display (such as a liquid crystal display) that provides the end user-perceivable indications, a current count of the number of RFID tags that have been read or for which the platform 500 has provided an annunciation during a current interrogation, and/or other such information.

The above examples are intended to serve an illustrative purpose and are not intended, by their specificity, to suggest any particular limitations in these regards.

These teachings will readily accommodate numerous other optional modifications as desired. As one example in these regards, the end-user platform 500 can further comprise an optical code reader 507 that operably couples to the control circuit 501. This optical code reader 507, for example, can comprise a bar code reader. Such an accommodation will permit the platform 500 to read, for example, standard Universal Product Codes (UPC's) in addition to EPC's, identifiers for modules, and/or other such information.

As another example in these regards, the end-user platform 500 can further comprise memory 508 that operably couples to the control circuit 501. This memory 508 can serve to store, for example, historical RFID tag data, presently-read data, identification information provided by the remote processor (or processors), parameters, settings and/or other such relevant information. Such a memory 508 can also serve to store, as another example, computer operating instructions, executable program code, instructions and the like that, when executed by the control circuit 501, will permit the latter to carry out the steps, actions, and/or functions described herein.

The memory 508 typically includes one or more processor readable and/or computer readable media accessed by at least the control circuitry 501, and can include volatile and/or nonvolatile media, such as RAM, ROM, EEPROM, flash memory and/or other memory technology. Further, the memory is shown as internal to the end-user platform 500; however, the memory 508 can be internal, external or a combination of internal and external memory. The external memory can be substantially any relevant memory such as, but not limited to, one or more of flash memory secure digital (SD) card, universal serial bus (USB) stick or drive, other memory cards, hard drive and other such memory or combinations of such memory. Similarly, the memory 508 can be internal to, external to or a combination of internal and external to the control circuitry 501. The memory 508 can store code, firmware, software, executables, scripts, identification information, module identification information, planogram information, portions of and/or all of RFID tag responses, data, coordinate information, programming, programs, textual content, identifiers, log or history data, user information and the like.

For many applications settings the end-user platform 500 can comprise a portable device having its own portable power supply (such as one or more batteries). It would also be possible for this platform 500, however, to couple via a power cord, power port and the like to a source of enabling power (such as a standard electrical power outlet, a computer, a remote processor, and the like).

Such an apparatus 500 may be comprised of a plurality of physically distinct elements as is suggested by the illustration shown in FIG. 5. It is also possible, however, to view this illustration as comprising a logical view, in which case one or more of these elements can be enabled and realized via a shared platform. It will also be understood that such a shared platform may comprise a wholly or at least partially programmable platform as are known in the art. In some embodiments, the end-user platform 500 is a portable, handheld RFID tag reader. Accordingly, the RFID tag reader 502, in some embodiments, is part of the portable, handheld RFID tag read that further incorporates one or more of the control circuit 501, the one or more annunciators 503, the transceiver 504, the end user interface 506, the optical code reader 507, the memory 508 and/or other components of a portable, handheld RFID tag reader. The handheld RFID tag reader typically includes a housing 509, casing or the like to protect the internal components (e.g., control circuit 501, RFID tag reader 502, annunciator, memory 508, etc.). As such, the housing can contain one or more of the control circuit, 501, the one or more annunciators 503, the transceiver 504, the end user interface 506, the optical code reader 507, the memory 508 and/or other components. In some embodiments, the housing is ergonomically configured to be portable and/or held in one hand by an end user, and activated (e.g., through one or more buttons, triggers or the like) to initiate an RFID tag interrogation.

So configured, these teachings will readily facilitate the convenient, efficient, and reliable reading of various pluralities of RFID tags in settings where the number of RFID tags is not necessarily well understood and/or where the end user is not a highly-trained technician. Further, the reading and/or scanning of various pluralities of RFID tags can be performed separate from one or more remote processors and while the RFID tag reader is not in communication with the one or more remote processors. For the sake of illustration but without intending any particular limitations in these regards, the RFID tag reader can be taken to storage containers, trucks, trailers and the like that are external to a retail building and/or where the RFID tag reader is out of range of and not in communication with the one or more remote processors and still perform the RFID tag readings and/or scans of various ones of pluralities of RFID tags in the storage containers, trucks, trailers, etc. These benefits, in turn, permit these teachings to be employed in highly cost-effective ways that can lead to reduced overhead expenditures. These savings, in turn, can then be passed along to the ultimate consumer. Again, the RFID tag reader can comprise a part of an integrated end-user platform that includes additional structure and/or programming to carry out some or all of the actions, steps, and functionality presented herein. Further, and as desired, the end-user platform can communicate with one or more remote processors to receive results of interrogation scans and/or facilitate the described functionality.

Some embodiments provide processor or computer program products comprising one or more medium configured to embody a computer program or programs for input to one or more processors or computers and a computer program embodied in the medium configured to cause the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs configured to cause a computer and/or processor based system to execute steps comprising: receiving, within a RFID tag reader and from a remote processor that is separate from the RFID tag reader, identification information corresponding to one or more RFID tags of interest, wherein the identification information distinguishes the one or more RFID tags of interest from other RFID tags that are not currently of interest; interrogating, after having received the identification information, a plurality of RFID tags while the RFID tag reader is remote from and not in communication with the remote processor; receiving at the RFID tag reader multiple corresponding RFID tag responses from various ones of the plurality of RFID tags; evaluating locally at the RFID tag reader each of the multiple RFID tag responses relative to at least the identification information; identifying, as a function of the evaluating, a plurality of RFID tags that are RFID tags of interest; and producing, locally at the RFID tag reader and in response to identifying the plurality of RFID tags of interest, end user-perceivable indications corresponding to at least one RFID tag response from each of the plurality of RFID tags of interest to thereby inform an end user of the RFID tag reader with respect to a corresponding reading state as regards to the plurality of RFID tags.

Other embodiments provide one or more computer-readable storage mediums storing one or more computer programs configured for use with a computer simulation, the one or more computer programs configured to cause a computer and/or processor based system to execute steps comprising: interrogating, from a handheld wireless RFID tag reader, a plurality of RFID tags; receiving at the RFID tag reader multiple corresponding RFID tag responses from various ones of the plurality of RFID tags; determining whether the RFID tag reader is in range with and in communication with a remote processor that is separate from the RFID tag reader; evaluating, locally at the RFID tag reader when the RFID tag reader is not within communication with the remote processor, each of the multiple RFID tag responses relative to at least identification information received at the RFID tag reader from the remote processor and locally stored at the RFID tag reader, wherein the identification information corresponds to one or more RFID tags of interest and distinguishes the one or more RFID tags of interest from other RFID tags that are not currently of interest; comparing, locally at the RFID tag reader when the RFID tag reader is not within communication with the remote processor, information in each of the multiple RFID tag responses with one or more identifiers defined within identification information received at the RFID tag reader from the remote processor and locally stored at the RFID tag reader; identifying, locally at the RFID tag reader when the RFID tag reader is not within communication with the remote processor and in response to the comparing, one or more of the plurality of RFID tag responses as RFID tags of interest when the one or more identifiers correspond to previously-established identifiers defined within the identification information received at the RFID tag reader from the remote processor; determining, locally at the RFID tag reader when the RFID tag reader is not within communication with the remote processor and as a function of the evaluating, whether a currently-read RFID tag is an RFID tag of interest; storing locally within the RFID tag reader at least a portion of information from each of the plurality of RFID tag responses received from RFID tags of interest; and producing, locally at the RFID tag reader when the RFID tag reader is not within communication with the remote processor and in response to determining that one or more currently-read RFID tags are RFID tags of interest, a end user-perceivable indication corresponding to the RFID tag responses from the plurality of RFID tags of interest to thereby inform an end user of the RFID tag reader with respect to a corresponding reading state as regards to the plurality of RFID tags.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A method to facilitate reading a plurality of radio frequency identification (RFID) tags, the method comprising:
receiving, within a RFID tag reader and from a remote processor that is separate from the RFID tag reader, identification information corresponding to one or more RFID tags of interest, wherein the identification information distinguishes the one or more RFID tags of interest from other RFID tags that are not currently of interest;
interrogating, after having received the identification information, a plurality of RFID tags while the RFID tag reader is remote from and not in communication with the remote processor;
receiving at the RFID tag reader multiple corresponding RFID tag responses from various ones of the plurality of RFID tags;
evaluating locally at the RFID tag reader each of the multiple RFID tag responses relative to at least the identification information;
identifying, as a function of the evaluating, a plurality of RFID tags that are RFID tags of interest; and
producing, locally at the RFID tag reader and in response to identifying the plurality of RFID tags of interest, end user-perceivable indications corresponding to at least one RFID tag response from each of the plurality of RFID tags of interest to thereby inform an end user of the RFID tag reader with respect to a corresponding reading state as regards to the plurality of RFID tags.

2. The method of claim 1, wherein the evaluating locally at the RFID tag reader each of the multiple RFID tag responses comprises comparing information in each of the multiple RFID tag responses with one or more identifiers specified within the identification information and stored on the RFID tag reader; and
wherein the identifying the plurality of RFID tags of interest comprises identifying an RFID tag as an RFID tag of interest when an identifier specified within a corresponding one of the multiple RFID tag responses corresponds to previously-established identifiers specified within the identification information received at the RFID tag reader from the remote processor.

3. The method of claim 2, wherein the evaluating locally at the RFID tag reader each of the multiple RFID tag responses further comprises:
assessing each of the multiple RFID tag responses to determine whether an RFID tag response corresponds to an already-read RFID tag; and
discarding those RFID tag responses that correspond to an already-read RFID tag such that an end user-perceivable indication is not produced for the discarded RFID tag responses.

4. The method of claim 2, wherein the evaluating locally at the RFID tag reader each of the multiple RFID tag responses comprises:
determining whether an RFID tag response correlates with an identifier for a first module of items of a plurality of modules of items; and
identifying the plurality of RFID tags of interest when the corresponding RFID tag responses correlate with the identifier of the first module of items and the one or more identifiers correspond to the previously-established identifiers defined within the identification information.

5. The method of claim 1, further comprising:
storing locally within the RFID tag reader at least a portion of information from each of the plurality of RFID tag responses received from RFID tags of interest.

6. The method of claim 5, further comprising:
detecting, at the RFID tag reader and after having interrogated the plurality of RFID tags, that the RFID tag reader is in communication with the remote processor; and
transmitting to the remote processor at least the portion of the information from each of the plurality of RFID tag responses received from the RFID tags of interest.

7. The method of claim 5, further comprising:
storing locally within the RFID tag reader at least a portion of information from an RFID tag response received from an RFID tag that is not of interest.

8. The method of claim 7, further comprising:
determining whether sufficient memory on the RFID tag reader is available to store at least the portion of the information from the RFID tag response received from the RFID tag that is not of interest;
freeing up memory on the RFID tag reader in response to determining that there is not sufficient memory to store at least the portion of the information from the RFID tag response from the RFID tag that is not of interest; and
storing locally within the RFID tag reader over the freed up memory at least the portion of the information from the RFID tag response received from the RFID tag that is not of interest.

9. The method of claim 5, further comprising:
storing locally within the RFID tag reader at least a portion of information from each of a plurality of RFID tag responses received from each of a plurality of RFID tags that are not of interest and that have not already previously responded to the interrogation.

10. An apparatus to facilitate reading a plurality of radio frequency identification (RFID) tags, the apparatus comprising:
a memory configured to store identification information received from a remote processor that is separate and remote from the apparatus, wherein the identification information corresponds to one or more RFID tags of interest and distinguishes the one or more RFID tags of interest from other RFID tags that are not currently of interest;
an RFID tag reader configured to interrogate a plurality of RFID tags while the RFID tag reader is remote from and not in communication with the remote processor, and to receive multiple corresponding RFID tag responses from various ones of the plurality of RFID tags;
a control circuit operatively coupled with the RFID tag reader and the memory, wherein the control circuit is configured to receive the multiple corresponding RFID tag responses from the RFID tag reader; locally evaluate each of the multiple RFID tag responses relative to at least the identification information; identify, as a function of the evaluation, a plurality of RFID tags are RFID tags of interest; and produce, in response to identifying the plurality of RFID tags of interest, end user-perceivable indication signals corresponding to RFID tag responses from each of the plurality of RFID tags of interest; and
an annunciator operably coupled with the control circuit, wherein the annunciator is configured to receive the end user-perceivable indication signals from the control circuit and to generate end user-perceivable indications corresponding to the RFID tag responses from each of the plurality of RFID tags of interest as a function of the end user-perceivable indication signals to thereby inform an end user of the apparatus with respect to a completeness level of the reading of the plurality of RFID tags.

11. The apparatus of claim 10, wherein the control circuit, in evaluating each of the multiple RFID tag responses, is further configured to compare information in each of the multiple RFID tag responses with one or more identifiers defined within the identification information and stored in the memory, and to identify an RFID tag as an RFID tag of interest when an identifier specified within a corresponding one of the multiple RFID tag responses corresponds to previously-established identifiers defined within the identification information received from the remote processor.

12. The apparatus of claim 11, wherein the control circuit, in evaluating each of the multiple RFID tag responses, is further configured to:
determine whether an RFID tag response correlates with an identifier for a first module of items of a plurality of modules of items; and
identify the plurality of RFID tags of interest when the corresponding RFID tag responses correlate with the identifier of the first module of items and the one or more identifiers correspond to the previously-established identifiers defined within the identification information.

13. The apparatus of claim 11, wherein the control circuit, in evaluating each of the multiple RFID tag responses, is further configured to assess each of the multiple RFID tag responses to determine whether an RFID tag response corresponds to an already-read RFID tag; and discard those RFID tag responses that correspond to an already-read RFID tag such that an end user-perceivable indication is not produced for the discarded RFID tag responses.

14. The apparatus of claim 10, further comprising:
a wireless transceiver operably coupled with the control circuit;
wherein the control circuit is further configured to detect, after having interrogated the plurality of RFID tags, that the control circuit is in communication with the remote processor, and to cause the wireless transceiver to transmit at least the portion of the information from each of the plurality of RFID tag responses received from the RFID tags of interest to the remote processor.

15. The apparatus of claim 10, wherein the control circuit is further configured to direct at least a portion of information from each of the plurality of RFID tag responses received from RFID tags of interest to be stored in the memory, and to direct at least a portion of information from RFID tag responses received from RFID tags that is not of interest to be stored in the memory.

16. The apparatus of claim 10, wherein the control circuit is further configured to determine whether a sufficient amount of the memory is available to store at least a portion of information from the RFID tag response received from RFID tag that are not of interest, free up a portion of the memory in response to determining that there is not sufficient amount of the memory to store at least the portion of the information from the RFID tag response from the RFID tag that is not of interest, and direct at least the portion of the information from the RFID tag response received from the RFID tag that is not of interest to be stored in the memory over the freed up memory.

17. The apparatus of claim 10, further comprising:
a housing, wherein the memory, the RFID tag reader, the control circuit and the annunciator are contained within the housing.

18. The apparatus of claim 17, wherein the housing comprises a portable, handheld housing.

19. A method to facilitate reading a plurality of radio frequency identification (RFID) tags, the method comprising:
interrogating, from a handheld wireless RFID tag reader, a plurality of RFID tags;
receiving at the RFID tag reader multiple corresponding RFID tag responses from various ones of the plurality of RFID tags;
determining whether the RFID tag reader is in range with and in communication with a remote processor that is separate from the RFID tag reader;
evaluating, locally at the RFID tag reader when the RFID tag reader is not within communication with the remote processor, each of the multiple RFID tag responses relative to at least identification information received at the RFID tag reader from the remote processor and locally stored at the RFID tag reader, wherein the identification information corresponds to one or more RFID tags of interest and distinguishes the one or more RFID tags of interest from other RFID tags that are not currently of interest;
comparing, locally at the RFID tag reader when the RFID tag reader is not within communication with the remote processor, information in each of the multiple RFID tag responses with one or more identifiers defined within identification information received at the RFID tag reader from the remote processor and locally stored at the RFID tag reader;
identifying, locally at the RFID tag reader when the RFID tag reader is not within communication with the remote processor and in response to the comparing, one or more of the plurality of RFID tag responses as RFID tags of interest when the one or more identifiers correspond to previously-established identifiers defined within the identification information received at the RFID tag reader from the remote processor;
determining, locally at the RFID tag reader when the RFID tag reader is not within communication with the remote processor and as a function of the evaluating, whether a currently-read RFID tag is an RFID tag of interest;
storing locally within the RFID tag reader at least a portion of information from each of the plurality of RFID tag responses received from RFID tags of interest; and
producing, locally at the RFID tag reader when the RFID tag reader is not within communication with the remote processor and in response to determining that one or more currently-read RFID tags are RFID tags of interest, a end user-perceivable indication corresponding to the RFID tag responses from the plurality of RFID tags of interest to thereby inform an end user of the RFID tag reader with respect to a corresponding reading state as regards to the plurality of RFID tags.

20. The method of claim 19, further comprising:
while the RFID tag reader is in communication with the remote processor and while receiving the responses:
transmitting at least a portion of at least some of the responses to the remote processor;
receiving from the remote processor a plurality of messages corresponding to RFID tags of interest as identified by the remote processor; and
providing at the RFID tag reader the plurality of end user-perceivable indications corresponding to the responses from the one or more of the plurality of RFID tags as a function of the messages received from the remote processor.
